(19) United States
(12) Patent Application Publication
(10) Pub. No.: US 2026/0187822 A1
(43) Pub. Date: Jul. 2, 2026

(54) POLYGON CHAIN SKELETON EXTRACTION METHOD

(71) Applicant: Shanghai Glorysoft Co., Ltd, Shanghai (CN)

(72) Inventors: Xiaochun DIAO, Shanghai (CN); Wenrui WANG, Shanghai (CN)

(73) Assignee: Shanghai Glorysoft Co., Ltd, Shanghai (CN)

(21) Appl. No.: 18/862,951

(22) PCT Filed: Sep. 4, 2023
(86) PCT No.: PCT/CN2023/116705

§ 371 Date: Nov. 5, 2024

(51) Int. Cl. G06T 7/269; G06T 5/30; G06T 7/00; G06T 7/13

(52) U.S. Cl. CPC G06T 7/269; G06T 5/30; G06T 7/0002; G06T 7/13; G06T 2207/20044

(57) ABSTRACT

The present invention discloses a polygon chain skeleton extraction method, which includes steps as follows: step 1, inputting a polygon image to be processed and obtaining a gradient flow of a polygon contour in the image; step 2: after generating the gradient flow, initializing a skeleton chain; step 3, constructing an objective function based on the gradient flow and the skeleton chain; step 4, iterating the objective function constructed, and when the termination condition is reached, extracting the skeleton line. The invention discloses a polygon chain skeleton extraction algorithm based on gradient flow, which can realize skeleton line identification of strip polygons of any form.

### TECHNICAL FIELD

The present invention relates to the technical field of image detection, and in particular to a polygon chain skeleton extraction algorithm.

### DESCRIPTION OF RELATED ART

In the process of defect image quality inspection, it is usually necessary to perform accurate polygon identification of defects. After identifying the polygon (such as the polygon in a white area in FIG. 1), it is usually necessary to extract the skeleton line from the strip polygon (such as the line in the white area in FIG. 1) to calculate the curvature, width, direction, and other information thereof to assist in defect classification and determination. The accuracy of identifying the position of the skeleton line greatly impacts the accuracy of defect identification.

Existing polygon skeleton extraction methods may be roughly divided into two types: (1) relying on the prior knowledge of the width of the strip polygon, finding anchor points using the inscribed circle method, and connecting the centers of multiple inscribed circles of the same radius to form a skeleton line; (2) using graphic operations to continuously erode the polygon into a chain-like or approximately chain-like shape, finding the endpoints of the single chains in the connected area, connecting all the single chain endpoints, and calculating the skeleton line thereof. However, the existing methods still have some disadvantages. Regarding the method (1), since the width range of the strip polygon needs to be known in advance, the application conditions thereof are relatively stringent. Therefore, when the width of the polygon varies significantly, the algorithm fails outside the preset radius. The anchor points of the skeleton line are not equidistant, which may lead to directional calculation deviations in defect shape determination. Regarding the method (2), it is necessary to perform multiple graphic operations on the polygons, with the iteration termination condition being whether a single pixel chain is formed. The operation thereof is relatively complex and the algorithm implementation is relatively lengthy. At the same time, there remains the issue that the anchor points of the skeleton line are not equidistant.

### SUMMARY

The present invention is made to solve the above-mentioned problem, and the purpose thereof is to provide an edge chain skeleton extraction algorithm.

In order to achieve the above purpose, the present invention adopts the following technical solutions:

The present invention provides a polygon chain skeleton extraction algorithm, which is characterized by including the following steps:
step 1, inputting a polygon image to be processed and obtaining a gradient flow of a polygon contour in the image;
step 2, after generating the gradient flow, initializing a skeleton chain;
step 3, constructing an objective function based on the gradient flow and the skeleton chain;
step 4, iterating the constructed objective function, and extracting skeleton line when a termination condition is reached.

Furthermore, the polygon chain skeleton extraction algorithm provided by the present invention may further have the following feature: in which the process of obtaining the gradient flow in step 1 includes: 1) calculating stacking information of each point using a dilation-erosion algorithm; 2) performing gradient flow calculation on the stacking information and obtaining a full-field gradient flow direction through Laplace operation.

Furthermore, the polygon chain skeleton extraction algorithm provided by the present invention may further have the following feature: in which in step 2, a series of tangent circles are generated as initial values for the iteration when the skeleton chain is initialized.

The objective function in step 3 is as follows:

$$I = α G + β C \qquad ( 1 )$$

$$G = {\sum }_{( {x}_{i} , {y}_{i} ) ∈ chain} {‖ {g}_{x} ( {x}_{i} , {y}_{i} ) + {g}_{y} ( {x}_{i} , {y}_{i} ) ‖}_{2} \qquad ( 2 )$$

$$C = {\sum }_{( {x}_{i} , {y}_{i} ) ∈ chain - 1} {( R - \sqrt{{( {x}_{i} - {x}_{i + 1} )}^{2} + {( {y}_{i} - {y}_{i + 1} )}^{2}} )}^{2} \qquad ( 3 )$$

In the formulas (1), (2) and (3), I is the objective function; α and β are proportionality coefficients; G is the sum of the moduli of the gradient direction of each point; C is the sum of the moduli of the distances between the anchor points of the skeleton chain; xᵢ is the horizontal coordinate of a point i; yᵢ is the vertical coordinate of the point i; xᵢ₊₁ is the horizontal coordinate of a point i+1; yᵢ₊₁ is the vertical coordinate of the point i+1; gₓ (xᵢ, yᵢ) is the gradient of the image along the x direction at a point (xᵢ, yᵢ); g_{y} (xᵢ, yᵢ) is the gradient of the image along the y direction at the point (xᵢ, yᵢ); chain is the set of all anchor points of the skeleton chain; chain-1 is the set of all anchor points of the skeleton chain, since the distance between two adjacent anchor points is calculated, a quantity calculated is 1 less than a total quantity of the anchor points; R is the isometric radius set during initialization.

Furthermore, the polygon chain skeleton extraction algorithm provided by the present invention may further have the following feature: in which,

In step 2, the tangent circle is not used as the skeleton chain during the skeleton chain initialization process.

The objective function in step 3 is as follows:

$$I = α G + β C \qquad ( 1 )$$

$$G = {\sum }_{( {x}_{i} , {y}_{i} ) ∈ chain} {‖ {g}_{x} ( {x}_{i} , {y}_{i} ) + {g}_{y} ( {x}_{i} , {y}_{i} ) ‖}_{2} \qquad ( 2 )$$

$$C = {\sum }_{( {x}_{i} , {y}_{i} ) ∈ chain - 1} {( {R}_{avg} - \sqrt{{( {x}_{i} - {x}_{i + 1} )}^{2} + {( {y}_{i} - {y}_{i + 1} )}^{2}} )}^{2} \qquad ( 4 )$$

$${R}_{avg} = \frac{1}{n - 1} {\sum }_{( {x}_{i} , {y}_{i} ) ∈ chain - 1} \sqrt{{( {x}_{i} - {x}_{i + 1} )}^{2} + {( {y}_{i} - {y}_{i + 1} )}^{2}} \qquad ( 5 )$$

In the formulas (1), (2), (4) and (5), I is the objective function; α and β are proportionality coefficients; G is the sum of the moduli of the gradient direction of each point; C is the sum of the moduli of the distances between the anchor points of the skeleton chain; xᵢ is the horizontal coordinate of a point i; yᵢ is the vertical coordinate of the point i; xᵢ₊₁ is the horizontal coordinate of a point i+1; yᵢ₊₁ is the vertical coordinate of the point i+1; gₓ (xᵢ, yᵢ) is the gradient of the image along the x direction at the point (xᵢ, yᵢ); g_{y} (xᵢ, yᵢ) is the gradient of the image along the y direction at the point (xᵢ, yᵢ); chain is the set of all anchor points of the skeleton chain; chain-1 is the set of all anchor points of the skeleton chain, since the distance between two adjacent anchor points is calculated, a quantity calculated is 1 less than a total quantity of the anchor points; R_{avg} is the average distance between anchor points in the skeleton chain; n is the quantity of all of the anchor points in the skeleton chain.

Furthermore, the polygon chain skeleton extraction algorithm provided by the present invention may further have the following feature: in which the iterative process includes two steps of gradient update and isometric update: during the gradient update process, each anchor point moves toward the direction of maximum gradient, and during the isometry update process, each anchor point moves toward the direction of optimal isometry.

Furthermore, the polygon chain skeleton extraction algorithm provided by the present invention may further have the following feature: in which the termination condition of the iteration is: before and after one iteration, the change of the objective function is less than a fixed value, that is:

$$abs ( I ( n ) - I ( n + 1 ) ) < ϵ . \qquad ( 6 )$$

Furthermore, the polygon chain skeleton extraction algorithm provided by the present invention may also have the following feature: wherein the sum of α and β in formula (1) is always kept equal to 1.

Furthermore, the polygon chain skeleton extraction algorithm provided by the present invention may further have the following feature: in which the polygon image to be processed input in step 1 is a strip polygon image.

### Beneficial Effects of the Present Invention

The polygon chain skeleton extraction algorithm of the present invention can realize skeleton line identification for strip polygons of any shape. The extraction algorithm of the present invention establishes a gradient flow of the defect contour in the full-field image and initializes the isometric chain at the same time. The construction of the optimization function is formed by two parts, one part is the maximum direction of gradient flow, and the other part is the equidistant between points. The two parts jointly limit the iteration direction. Since the constructed optimization function is universal, the optimal solution may be obtained using elementary iteration method or Newton iteration method. The algorithm of the present invention does not rely on prior knowledge, but only needs to iterate through the steps to construct the function, and is suitable for defect identification scenarios with complex conditions.

### BRIEF DESCRIPTION OF THE DRAWINGS

FIG. 1 is an example diagram of a polygon skeleton line;

FIG. 2 is a flow chart of a polygon chain skeleton extraction algorithm of the present invention;

FIG. 2 is a schematic diagram of a polygonal contour before and after a gradient flow is obtained in an embodiment of the present invention, (a) is a polygon image to be processed, and (b) is an image after processing;

FIG. 4 is a schematic diagram showing that initialization generates a series of tangent circles in an embodiment of the present invention;

FIG. 5 is a schematic diagram of generating a plurality of plotting points in the image after initialization in an embodiment of the present invention;

FIG. 6 is a schematic diagram of each anchor point moving toward a direction of maximum gradient during a gradient update process in an embodiment of the present invention;

FIG. 7 is a schematic diagram of each anchor point moving toward a direction of optimal isometry during an isometry update process in an embodiment of the present invention;

FIG. 8 is a schematic diagram of an iterative optimization process in an embodiment of the present invention.

### DESCRIPTION OF THE EMBODIMENTS

In order to make the technical means, creative features, objectives, and effects achieved by the present invention more comprehensible, the following embodiments are combined with the accompanying drawings to specifically illustrate the technical solutions of the present invention.

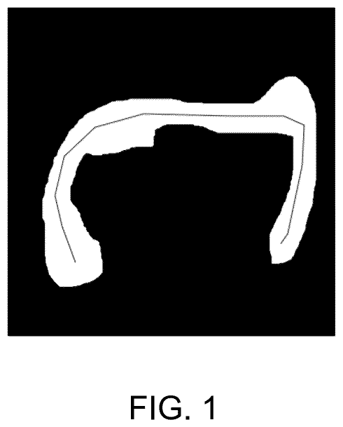

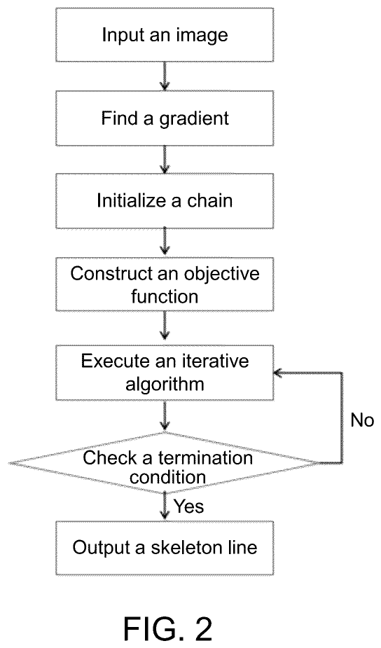

Referring to FIG. 1, an embodiment of the present invention provides a polygon chain skeleton extraction algorithm, including the following steps:

Step 1: a polygon image to be processed is input and a gradient flow of a polygon contours in the image is obtained.

The input polygon image to be processed is an image of a strip polygon in any shape.

The process of obtaining the gradient flow includes:
1) A dilation-erosion algorithm is used to calculate stacking information of each point, and the image obtained after processing is shown in FIG. 3 (b).

2) Gradient flow calculation is performed on the stacking information, and a full-field gradient flow direction is obtained through Laplace operation.

The stacking information is incremented sequentially. At points not reaching the center of the strip polygon, a maximum gradient direction thereof points toward the center of the graphic. At the stacking maximum, that is, near the center of the image, the gradient direction may change, but the second norm (magnitude) of the gradient reaches a minimum value.

Step 2: after generating the gradient flow, a skeleton chain is initialized.

The goal of the algorithm for the skeleton chain is to output a set of equidistant skeleton chains.

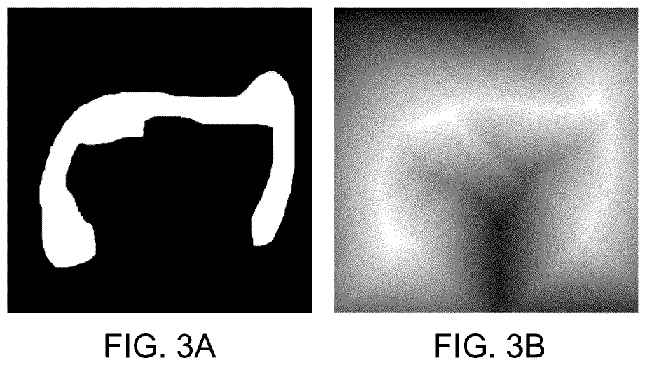

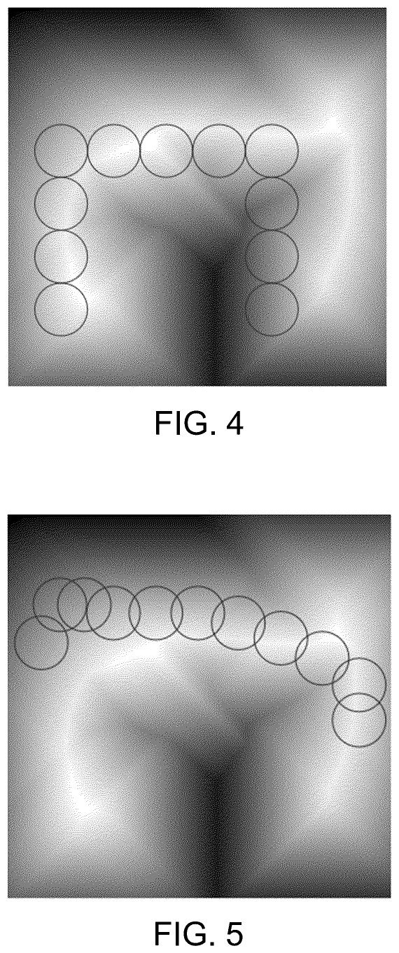

When the skeleton chain is initialized in the step, as shown in FIG. 4, the preferred method is to generate a series of tangent circles as initial values for the iteration. During the initialization process of the skeleton chain in the step, tangent circles may not necessarily be used as the skeleton chain.

Step 3: an objective function is constructed based on the gradient flow and the skeleton chain.

The objective function is as follows:

$$I = α G + β C \qquad ( 1 )$$

In formula (1), I is the objective function; α and β are proportional coefficients, which may be set according to the actual situation in the actual identification work. It is preferred to set the sum of α and β to always remains equal to 1. G is the sum of the moduli of the gradient direction of each point; C is the sum of the moduli of the distances between the anchor points of the skeleton chain.

In the objective function, the first part G is the sum of the moduli of the gradient direction of each point, which has a minimum value at the maximum stacking point, that is, the central area of the polygon. The second part C is the sum of the moduli of the distances between the anchor points of the skeleton chain, which reaches a minimum value of 0 at the equidistant point, that is, the chain has the best equidistant property. In the process of iterative approximation of the optimization function I to the minimum value, the gradient flow provides the external force in the direction of movement of the skeleton chain, and the isometry provides the internal force of the geometric shape of the skeleton chain. The internal and external forces work together to find the optimal solution.

The function of G is as follows:

$$G = {\sum }_{( {x}_{i} , {y}_{i} ) ∈ chain} {‖ {g}_{x} ( {x}_{i} , {y}_{i} ) + {g}_{y} ( {x}_{i} , {y}_{i} ) ‖}_{2} \qquad ( 2 )$$

In formula (2), xᵢ is the horizontal coordinate of a point i; yᵢ is the vertical coordinate of the point i; gₓ (xᵢ, yᵢ) is the gradient of the image along the x direction at the point (xᵢ, yᵢ); g_{y} (xᵢ, yᵢ) is the gradient of the image along the y direction at the point (xᵢ, yᵢ); chain is the set of all anchor points of the skeleton chain.

C functions are divided into two cases:

1) When a series of tangent circles are generated during the initialization process, the calculation of C uses the set equidistant radius R. Using an initial fixed value for R is beneficial to the convergence of the iteration. The calculation formula of C is as follows:

$$C = {\sum }_{( {x}_{i} , {y}_{i} ) ∈ chain - 1} {( R - \sqrt{{( {x}_{i} - {x}_{i + 1} )}^{2} + {( {y}_{i} - {y}_{i + 1} )}^{2}} )}^{2} \qquad ( 3 )$$

In formula (3), xᵢ is the horizontal coordinate of a point i; yᵢ is the vertical coordinate of the point i; xᵢ₊₁ is the horizontal coordinate of a point i+1; yᵢ₊₁ is the vertical coordinate of the point i+1; chain-1 is the set of all anchor points of the skeleton chain, since the distance between two adjacent anchor points is calculated, a quantity calculated is 1 less than a total quantity of the anchor points; R is the isometric radius set during initialization.

2) When isometric calculation is performed without using R value, the calculation formula of C is as follows:

$$C = {\sum }_{( {x}_{i} , {y}_{i} ) ∈ chain - 1} {( {R}_{avg} - \sqrt{{( {x}_{i} - {x}_{i + 1} )}^{2} + {( {y}_{i} - {y}_{i + 1} )}^{2}} )}^{2} \qquad ( 4 )$$

$${R}_{avg} = \frac{1}{n - 1} {\sum }_{( {x}_{i} , {y}_{i} ) ∈ chain - 1} \sqrt{{( {x}_{i} - {x}_{i + 1} )}^{2} + {( {y}_{i} - {y}_{i + 1} )}^{2}} \qquad ( 5 )$$

In Formula (4) (5), xᵢ is the horizontal coordinate of a point i; yᵢ is the vertical coordinate of the point i; xᵢ₊₁ is the horizontal coordinate of a point i+1; yᵢ₊₁ s the vertical coordinate of the point i+1; chain-1 is the set of all anchor points of the skeleton chain, since the distance between two adjacent anchor points is calculated, a quantity calculated is 1 less than a total quantity of the anchor points; R_{avg} is the average distance between anchor points in the skeleton chain; n is is the quantity of all of the anchor points in the skeleton chain.

step 4. Iterate the constructed objective function, and when a termination condition is reached, extract the skeleton line.

The termination condition of the iteration is: before and after one iteration, the change of the objective function is less than a fixed value, that is:

$$abs ( I ( n ) - I ( n + 1 ) ) < ϵ \qquad ( 6 )$$

When the iteration termination condition is reached, the skeleton chain changes slightly after each iteration and can be considered stable (the specific change that qualifies as stable may be pre-defined manually). When the result changes significantly, the change ratio may be used as the termination condition, such as 0.5%.

$$abs ( \frac{I ( n ) - I ( n + 1 )}{I ( n )} ) < ϵ$$

The iterative process includes two steps of gradient update and isometric update.

For ease of expression, a non-isometric skeleton chain is used as the initial value for the iteration to describe the algorithm iteration process. The actual iteration process is completed by the optimization function, as shown in FIG. 5, in which several anchor points are generated.

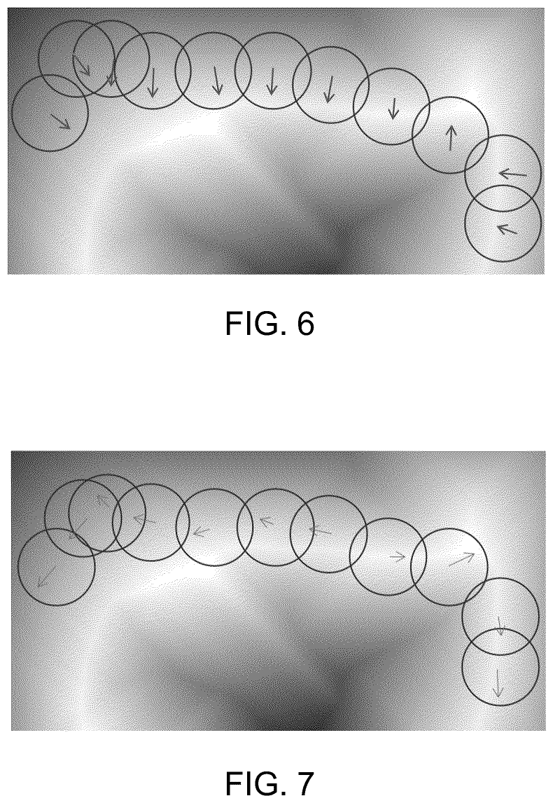

During the gradient update process, each anchor point moves toward the direction of maximum gradient. Referring to FIG. 6, in the drawing, the direction of the arrow is the direction in which the anchor point moves along the gradient.

During the isometry update process, each anchor point moves toward the direction of optimal isometry. Referring to FIG. 7, in the drawing, the direction of the arrow is the direction in which the anchor point moves along the optimal isometry.

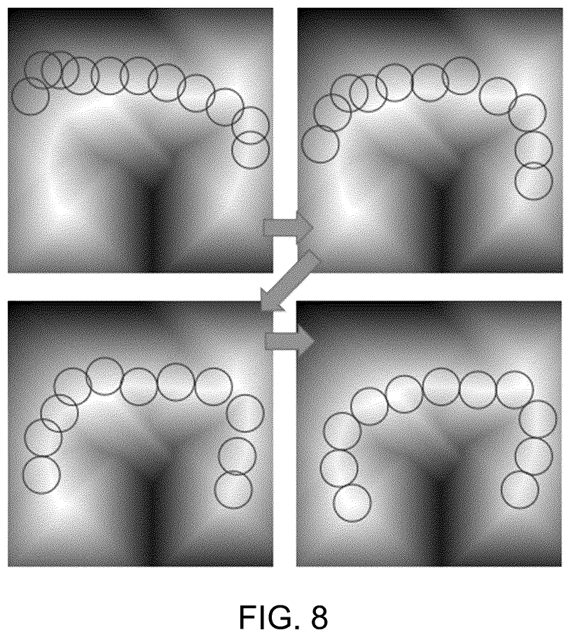

After multiple iterations, the optimal state is finally reached. In the early stages of iteration, isometry may be prioritized so that the skeleton lines are “effectively spread out” at various locations of the defect. Then, the proportional relationship between α and β is gradually adjusted to give more weight to the gradient, so that the skeleton chain iterates along the gradient. The sum of α and β always remains equal to 1, which is to normalize the relationship between gradient flow and isometry. Although this has no significance for the rate of change of the objective function, it has dimensional significance for the iteration termination condition, which can avoid the situation where the algorithm result keeps oscillating near the optimal point, and the efficiency of the algorithm is improved. Referring to FIG. 8, an iterative optimization process is illustrated, and it may be seen that the initialized skeleton chain gradually approaches the optimal position.

It may be seen from the above embodiments that the polygon chain skeleton extraction algorithm of the present invention can realize skeleton line identification of strip polygons. Also, since the constructed objective function is universal, the optimal solution may be obtained using elementary iteration or Newton iteration method. Therefore, the algorithm of the present invention has the significant advantage of not relying on prior knowledge, only needs to iterate through the steps to construct the function, and is suitable for defect identification scenarios with complex conditions.

The above embodiments are only preferred embodiments of the present invention and are not intended to limit the protection scope of the present invention. Any modifications, equivalent substitutions, improvements, etc. made within the spirit and principles of the present invention are included in the protection scope of the present invention.

1. A polygon chain skeleton extraction method, characterized by comprising steps as follows:
step 1, inputting an image, which is a polygon image, to be processed and obtaining a gradient flow of a polygon contour in the image;
step 2, initializing a skeleton chain after generating the gradient flow;
step 3, constructing an objective function based on the gradient flow and the skeleton chain;
step 4, iterating the objective function constructed, and extracting skeleton line when a termination condition is reached.

2. The polygon chain skeleton extraction method as claimed in claim 1,
wherein, process of obtaining the gradient flow in step 1 comprises:
1) using an dilation-erosion algorithm to calculate stacking information of each point;
2) performing gradient flow calculation on the stacking information, and obtaining a full-field gradient flow direction through Laplace operation.

3. The polygon chain skeleton extraction method as claimed in claim 1,
wherein, when initializing the skeleton chain in step 2, a series of tangent circles are generated as initial values for iteration.

4. The polygon chain skeleton extraction method as claimed in claim 3,
wherein, the objective function in step 3 comprises following formulas:
$$I = α G + β C , \qquad ( 1 )$$
$$G = {\sum }_{( {x}_{i} , {y}_{i} ) ∈ chain} {‖ {g}_{x} ( {x}_{i} , {y}_{i} ) + {g}_{y} ( {x}_{i} , {y}_{i} ) ‖}_{2} , \qquad ( 2 )$$
$$C = {\sum }_{( {x}_{i} , {y}_{i} ) ∈ chain - 1} {( R - \sqrt{{( {x}_{i} - {x}_{i + 1} )}^{2} + {( {y}_{i} - {y}_{i + 1} )}^{2}} )}^{2} , \qquad ( 3 )$$
in the formulas (1), (2) and (3), I is the objective function; α and β are proportionality coefficients; G is a sum of moduli of a gradient direction of each point; C is a sum of moduli of distances between anchor points of the skeleton chain; xᵢ is a horizontal coordinate of a point i; yᵢ is a vertical coordinate of the point i; xᵢ₊₁ is a horizontal coordinate of a point i+1; yᵢ₊₁ is a vertical coordinate of a point i+1; gₓ (xᵢ, yᵢ) is a gradient of the image along an x direction at a point (xᵢ, yᵢ); g_{y} (xᵢ, yᵢ) is a gradient of the image along a y direction at the point (xᵢ, yᵢ); chain-1 is a set of all of the anchor points of the skeleton chain, since a distance between two adjacent anchor points is calculated, a quantity calculated is 1 less than a total quantity of the anchor points; R is an isometric radius set during initialization.

5. The polygon chain skeleton extraction method as claimed in claim 1,
wherein, in step 2, the tangent circle is not used as the skeleton chain during process of initializing the skeleton chain.

6. The polygon chain skeleton extraction method as claimed in claim 5,
wherein, the objective function in step 3 comprises following formulas:
$$I = α G + β C , \qquad ( 1 )$$
$$G = {\sum }_{( {x}_{i} , {y}_{i} ) ∈ chain} {‖ {g}_{x} ( {x}_{i} , {y}_{i} ) + {g}_{y} ( {x}_{i} , {y}_{i} ) ‖}_{2} , \qquad ( 2 )$$
$$C = {\sum }_{( {x}_{i} , {y}_{i} ) ∈ chain - 1} {( {R}_{avg} - \sqrt{{( {x}_{i} - {x}_{i + 1} )}^{2} + {( {y}_{i} - {y}_{i + 1} )}^{2}} )}^{2} , \qquad ( 4 )$$
$${R}_{avg} = \frac{1}{n - 1} {\sum }_{( {x}_{i} , {y}_{i} ) ∈ chain - 1} \sqrt{{( {x}_{i} - {x}_{i + 1} )}^{2} + {( {y}_{i} - {y}_{i + 1} )}^{2}} , \qquad ( 5 )$$
in the formulas (1), (2), (4) and (5), I is the objective function; α and β are proportionality coefficients; G is a sum of moduli of a gradient direction of each point; C is a sum of moduli of distances between anchor points of the skeleton chain; xᵢ is a horizontal coordinate of a point i; yᵢ is a vertical coordinate of the point i; xᵢ₊₁ is a horizontal coordinate of a point i+1; yᵢ₊₁ s a vertical coordinate of the point i+1; gₓ (xᵢ, yᵢ) is a gradient of the image along an x direction at a point (xᵢ, yᵢ); g_{y} (xᵢ, yᵢ) is a gradient of the image along a y direction at the point (xᵢ, yᵢ); chain is a set of all of the anchor points of the skeleton chain; chain-1 is a set of all anchor points of the skeleton chain, since a distance between two adjacent anchor points is calculated, a quantity calculated is 1 less than a total quantity of the anchor points; R_{avg} is an average distance between the anchor points in the skeleton chain; n is a quantity of all of the anchor points in the skeleton chain.

7. The polygon chain skeleton extraction method as claimed in claim 4,
wherein, process of iterating comprises two steps of gradient update and isometric update:
during process of the gradient update, each of the anchor points moves toward a direction of maximum gradient,
during process of the isometry update, each of the anchor points moves toward a direction of optimal isometry.

8. The polygon chain skeleton extraction method as claimed in claim 4,
wherein, the termination condition for iterating is: before and after one iteration, a change of the objective function is less than a fixed value, that is:
$$abs ( I ( n ) - I ( n + 1 ) ) < ϵ . \qquad ( 6 )$$

9. The polygon chain skeleton extraction method as claimed in claim 4,
wherein, in the formula (1), a sum of α and β always remains equal to 1.

10. The polygon chain skeleton extraction method as claimed in claim 1,
wherein, the polygon image to be processed input in step 1 is a strip polygon image.

11. The polygon chain skeleton extraction method as claimed in claim 6,
wherein, process of iterating comprises two steps of gradient update and isometric update:
during process of the gradient update, each of the anchor points moves toward a direction of maximum gradient,
during process of the isometry update, each of the anchor points moves toward a direction of optimal isometry.

12. The polygon chain skeleton extraction method as claimed in claim 6,
wherein, the termination condition for iterating is: before and after one iteration, a change of the objective function is less than a fixed value, that is:
$$abs ( I ( n ) - I ( n + 1 ) ) < ϵ . \qquad ( 6 )$$

13. The polygon chain skeleton extraction method as claimed in claim 6,
wherein, in the formula (1), a sum of α and β always remains equal to 1.
